(19) United States
(12) Patent Application Publication
(10) Pub. No.: US 2024/0320833 A1
(43) Pub. Date: Sep. 26, 2024

(54) ULTRASONIC IMAGE QUALITY QUANTITATIVE EVALUATION METHOD

(71) Applicant: SHENZHEN INSTITUTES OF ADVANCED TECHNOLOGY CHINESE ACADEMY OF SCIENCES, Shenzhen (CN)

(72) Inventors: Yingying HAN, Shenzhen (CN); Ying HU, Shenzhen (CN); Baoliang ZHAO, Shenzhen (CN); Yuxin SONG, Shenzhen (CN); Ziwen WANG, Shenzhen (CN); Peng ZHANG, Shenzhen (CN)

(73) Assignee: SHENZHEN INSTITUTES OF ADVANCED TECHNOLOGY CHINESE ACADEMY OF SCIENCES, Shenzhen (CN)

(21) Appl. No.: 18/199,377

(22) Filed: May 19, 2023

Related U.S. Application Data
(63) Continuation of application No. PCT/CN2023/083131, filed on Mar. 22, 2023.

(51) Int. Cl. G06T 7/00; G06T 7/11

(52) U.S. Cl. CPC G06T 7/0016; G06T 7/11; G06T 2207/10132

(57) ABSTRACT

An ultrasonic image quality quantitative evaluation method includes segmenting a focus area aiming at a target ultrasonic image to extract a region of interest and perform a masking operation to acquire an image segmentation result mask; taking the image segmentation result mask as a reference image, and quantitatively comparing the reference image with a corresponding focus area according to a set evaluation standard to acquire a plurality of evaluation result indexes; and inputting the plurality of evaluation result indexes as an image feature into a classifier to acquire a quality quantification result of the focus area of the target ultrasonic image, where the classifier takes the plurality of evaluation result indexes corresponding to a sample image as an input feature, takes an image quality label of the labeled focus area as an output, and acquires the quality quantification result through training based on a set loss function.

### CROSS-REFERENCE TO THE RELATED APPLICATION

This application is a continuation application of PCT/CN2023/083131 filed on Mar. 22, 2023, the entire content of which is incorporated herein by reference.

### TECHNICAL FIELD

The present application relates to the technical field of image analysis, and in particular, to an ultrasonic image quality quantitative evaluation method.

### BACKGROUND

Ultrasonic images are widely used clinically due to affordable, nonradiative, non-invasive, real-time, and other characteristics. In order to reduce the burden of doctors and ensure the quality and consistency of the ultrasonic images, the automatic acquisition of the ultrasonic images by using a robot becomes a research hotspot in the time. Since the position, direction of an ultrasonic probe and the contact condition between the ultrasonic probe and a detected person obviously influence the quality of the ultrasonic images, and the ultrasonic images have characteristics of a large amount of noise and artifacts, low resolution, fuzzy boundary, low contrast ratio and the like on imaging characteristics, a priority step in the ultrasonic automatic acquisition is to evaluate the quality of the acquired ultrasonic images and feed the quality back to a robot control system to adjust a pose of the ultrasonic probe.

In the field of medical ultrasonic image processing, the demand for image quality evaluation is more urgent and difficult. Simply based on the image global content, the quality evaluation method cannot fully adapt to the complex cognitive process of the doctors in evaluating the quality of the ultrasonic images containing the focus, and to some extent, it deviates from the true clinical demand for the ultrasonic image quality evaluation. The clinicians need to evaluate the diagnostic value of an ultrasonic image rather than simply based on the quality evaluation of the image global content. Therefore, it is necessary to further supplement and refine the original global image quality evaluation method. After further discussion with the doctors, it can be learned that for the ultrasonic images containing the focus, the doctors are more concerned about the imaging quality of the focus area, whether the imaging of the focus area is complete, whether the boundary is easy to distinguish and the like. The imaging quality of the focus area determines the diagnostic value of the ultrasonic images containing the focus.

In the prior art, Hong Lao et al. proposed an automatic image quality evaluation solution based on multi-task learning, which utilizes features extracted by a convolutional neural network to judge whether an anatomical structure meets a standard, and delivers the anatomical structure to an area suggestion network to identify the position of the anatomical structure. Research teams from Shenzhen University and Shenzhen University Maternity and Child Healthcare Hospital proposed a multi-task learning framework using a faster regional convolutional neural network (MF R-CNN) for quality evaluation of fetal head ultrasonic images. The solution can detect and identify the key anatomical structure of the fetal head, analyze whether the magnification of the ultrasonic images is proper, and then perform the quality evaluation on the ultrasonic images according to the clinical solution drawn up together with the experienced doctors.

Upon analysis, for the local image quality evaluation of the focus area, current difficulties are mainly reflected in the following aspects:
1) Lack of high-quality reference images. The existing reference image quality evaluation method is inapplicable to the evaluation of the local image quality of the focus area, which is the problem faced by all medical image quality evaluation.
2) Limited number of images of focus area. In the field of medical image processing, medical data with annotations are already scarce, and the collection cost of the images containing the focus area and annotations is high, such that a deep learning method with high requirements on the dataset size is difficult to fully play a role in a task of evaluating the image quality of the focus area.
3) In the field of medical image processing, researchers increasingly pay more attention to the interpretability of algorithms, and it is difficult to develop the interpretability by relying on deep learning algorithms.

### SUMMARY

A purpose of the present application is to provide an ultrasonic image quality quantitative evaluation method aiming at troubles faced by local image quality evaluation of a focus area, explore and deconstruct a cognitive process aiming at ultrasonic image quality evaluation of the focus area. The method includes the following steps:
segmenting a focus area aiming at a target ultrasonic image to extract a region of interest and perform a masking operation to acquire an image segmentation result mask, wherein the image segmentation result mask corresponds to a focus area outline;
taking the image segmentation result mask as a reference image, and quantitatively comparing the reference image with a corresponding focus area according to a set evaluation standard to acquire a plurality of evaluation result indexes; and
inputting the plurality of evaluation result indexes as an image feature into a classifier to acquire a quality quantification result of the focus area of the target ultrasonic image, wherein the classifier takes the plurality of evaluation result indexes corresponding to a sample image as an input feature, takes an image quality label of the labeled local focus area as an output, and acquires the quality quantification result through training based on a set loss function.

Compared with the prior art, an advantage of the present application is that it provides an ultrasonic image quality quantitative evaluation method, which is a new technical solution for the local image quality evaluation of a semi reference focus area based on image segmentation. By creative introduction of a segmentation mask acquired from a segmentation task, an original problem of non-reference image quality evaluation is transformed into a problem of semi reference image quality evaluation, solving a problem of currently lacking of high-quality reference images. In addition, the present application uses the segmented mask as a reference image, uses a plurality of local image quality evaluation indexes of the focus area, and represents the similarity between a local image of the focus area and the segmented mask from a perspective of image semantic structure and image pixel statistics, such that the proposed ultrasonic image quality evaluation method has strong interpretability.

Other features of the present application and advantages thereof will become apparent from the following detailed description of exemplary embodiments of the present application with reference to the accompanying drawings.

### BRIEF DESCRIPTION OF THE DRAWINGS

The accompanying drawings, which are incorporated in and constitute a part of the specification, illustrate the embodiments of the present application and, together with the description, serve to explain the principles of the present application.

FIG. 1 is a flowchart of an ultrasonic image quality quantitative evaluation method according to an embodiment of the present application;

FIG. 2 is a schematic diagram of an overall process of an ultrasonic image quality quantitative evaluation method according to an embodiment of the present application;

FIG. 3 is a schematic diagram of a foreground image and a background image of a region of interest according to one embodiment of the present application,

FIG. 4 is a schematic diagram of a segmentation result between a mask of a region of interest and OTSU according to an embodiment of the present application; and

FIG. 5 is a schematic structural diagram of a multi-layer perceptron according to an embodiment of the present application.

### DETAILED DESCRIPTION OF THE EMBODIMENTS

Various exemplary embodiments of the present application will now be described in detail with reference to the accompanying drawings. It should be noted that the relative arrangement of the components and steps, the numerical expressions and numerical values set forth in the embodiments do not limit the scope of the present application unless it is specifically stated otherwise.

The following description of at least one exemplary embodiment is merely illustrative in nature and is in no way intended to limit the present application, application thereof or use thereof.

Techniques, methods, and devices known to those of ordinary skills in the relevant art may not be discussed in detail, but the techniques, methods, and devices should be considered as a part of the specification where appropriate.

In all examples shown and discussed herein, any specific value should be construed as exemplary only rather than limiting. Thus, other examples of the exemplary embodiments may have different values.

It should be noted that: similar reference numbers and letters refer to similar items in the following figures, and thus, once an item is defined in one figure, it does not need to be further discussed in subsequent figures.

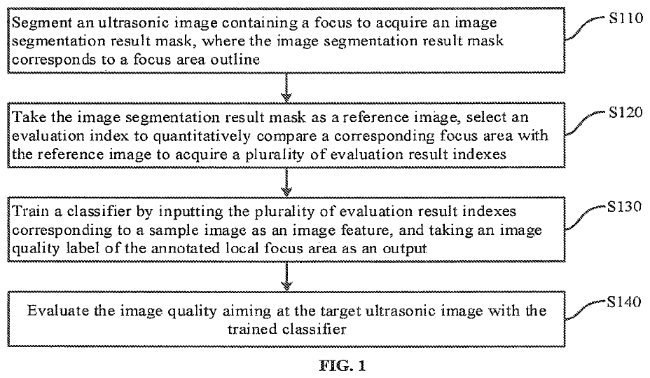

In combination with FIG. 1 and FIG. 2, the ultrasonic image quality quantitative evaluation method provided herein includes the following steps.

In step S110, an ultrasonic image containing a focus is segmented to acquire an image segmentation result mask, where the image segmentation result mask corresponds to a focus area outline.

In one embodiment, the ultrasonic image containing the focus may be segmented by training an image segmentation network to extract a region of interest (ROI).

Firstly, data preprocessing is performed, for example, center cutting is performed on the original ultrasonic image containing the focus, such that redundant contents such as patient information, equipment information and acquisition information are removed by cutting, and only the content of the ultrasonic image in the middle of the image is reserved. After the data preprocessing, an experienced professional physician manually annotates an ultrasonic image containing a focus area. For example, an outer outline of a nodal area in ultrasound is delineated.

Then, during the training of the image segmentation network, ultrasonic data which are annotated by the doctor containing the focus area are divided into a training set and a test set. The image segmentation network is trained so as to segment the focus area, and the region of interest is extracted from a segmentation result as a reference image for subsequent evaluation. The ultrasonic image segmentation result mask corresponds to the focus area outline, such that an original non-reference image quality evaluation task becomes a semi reference image quality evaluation task after acquiring the segmented mask result.

It should be noted that the image segmentation network may employ various types of neural networks, such as a U-net network.

In step S120, the image segmentation result mask is taken as a reference image, an evaluation index is selected to quantitatively compare a corresponding focus area with the reference image to acquire a plurality of evaluation result indexes.

In step S120, the segmentation result mask is used as the reference image, and the corresponding focus area is quantitatively compared with the segmentation result mask. In one embodiment, in a quantitative comparison evaluation process, evaluation indexes of mean square error and peak signal-to-noise ratio in full reference image quality evaluation are used, which measure a difference between an image of the focus area and a reference image mask at a pixel level. In addition, two other evaluation indexes are designed, that is, focus contrast ratio and structural similarity. The four indexes are combined to be used as a basis of image quality evaluation.

Specifically, the mean square error (MSE) is used for evaluating a mean value of a difference value between two images, and may be expressed by the following equation:

$$MSE = \frac{1}{MN} {\sum }_{x = 0}^{M - 1} {\sum }_{y = 0}^{N - 1} {[ A ( x , y ) - B ( x , y ) ]}^{2} \qquad ( 1 )$$

where A and B represent two images to be compared. A(x, y) and B(x, y) represent gray values of a pixel (x, y) in an image A and an image B, respectively. M and N represent the number of pixels in a length direction and a width direction, respectively.

The peak signal-to-noise ratio (PSNR) is used for measuring a ratio of an intensity of a peak signal to an average intensity of noise, which is typically logarithmic to become decibels (dB). The intensity of the noise may be defined by MSE, because MSE is an average value of a difference value between a real image and an image containing the noise, and the difference value between the real image and the image containing the noise is an intensity of the noise. The intensity of the peak signal is determined by a maximum gray value in the image. PSNR is defined as follows:

$$PSNR = 10 {log}_{10} \frac{{MaxValue}^{2}}{MSE} \qquad ( 2 )$$

where MaxValue is a maximum gray value in an image, and MSE is a mean square error of two images.

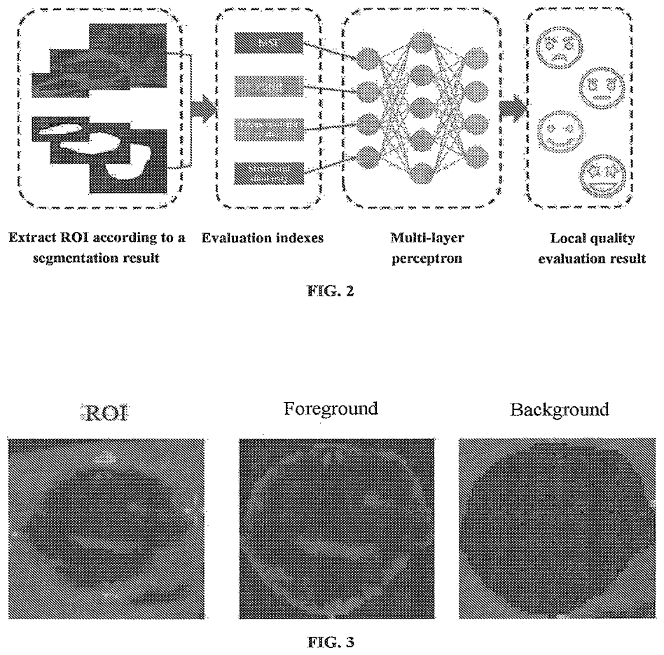

The index of the focus contrast ratio is set to represent distinguishability between an image of the focus area and a focus surrounding area. Generally, in the ultrasonic image, the image of the focus area is darker than the image of the surrounding normal tissue area, since the echo of the focus area is weaker than that of other tissue areas, and a low echo state is presented. The larger the difference between the gray value of the image of the focus area and the gray value of the image of the surrounding area is, the easier the image of the focus is to be distinguished, and the image quality of the focus area is more favorable to a high-quality image. In one embodiment, the focus contrast ratio is defined as a difference value between an image pixel mean value of the focus surrounding area and an image pixel mean value of the focus area divided by a maximum pixel value. Since a gray image is used, a maximum pixel value number is 255, the acquired pixel mean value of the image of the focus area and the pixel mean value of the image of the focus surrounding area are based on a mask of the segmentation result, the extracted ROI is divided into a background and a foreground, and pixel mean values thereof are respectively calculated. Referring to FIG. 3 for an example of the foreground and background of an ROI, the value of pixels outside the image of the focus area is set to 0 in the foreground of the ROI, and the value of pixels of the image of the focus area is set to 0 in the background of the ROI.

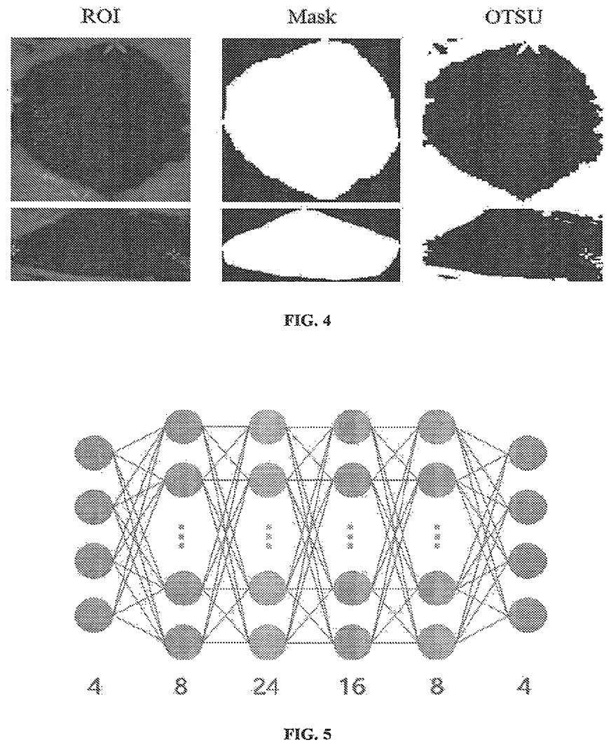

The index of the structural similarity is used for measuring a degree of the structural similarity between focus area imaging and a reference image mask. In one embodiment, the structural similarity is defined as a Dice coefficient between a segmentation result acquired by using on OTSU (Maximum Between-Class Variance Method) threshold segmentation algorithm on the ROI area and the reference image mask. Refer to FIG. 4 for the result acquired from different images and their reference image masks, OTSU (Maximum Between-Class Variance Method) segmentation. It can be seen from FIG. 4 that the OTSU algorithm has a good segmentation effect on an image with a clear edge, a complete boundary, and a significant difference between the focus area and the surrounding, and has a poor segmentation result on an image with an incomplete boundary. The clearer the edge of the focus area, the more complete the boundary and the more obvious the difference with the surrounding area, the better the segmentation effect of the image using the OTSU algorithm is, and the closer the image is to the mask, such that the imaging quality of the focus area can be measured to a certain extent by using the mask of the image of the focus area calculated using the Dice coefficient and the segmentation result of the OTSU algorithm.

In summary, the two evaluation indexes of MSE and PSNR measure the difference between the image of the focus area and the reference image mask at the pixel level. Furthermore, considering that only counting and measuring the difference between the image of the focus area and the reference image mask at the pixel level is not sufficient as a complete basis for the image quality evaluation, the two indexes of the focus contrast ratio and the structural similarity are further designed. It should be understood that other indexes may also be used to measure the image quality, and through experimentation and verification, the four indexes are preferably used to measure the quality of the focus area while considering the accuracy and efficiency of the evaluation.

In step S130, a classifier is trained by inputting the plurality of evaluation result indexes corresponding to a sample image as an image feature, and taking an image quality label of the annotated local focus area as an output.

Step S120 introduces the four evaluation indexes for measuring the image quality of the local focus area, and the four indexes are found to be in positive correlation with the annotated result but not simple linear relationship by analyzing the indexes and the manually annotated result of the doctor. In order to find the relationship between the four indexes and the manually annotated result of the doctor, the relationship may be acquired by training through the constructed classifier. The classifier may employ various types of neural network models, such as a convolutional neural network.

For example, a multi-layer perceptron is designed as the classifier to perform the image quality evaluation of the local focus area. In a training process, the acquired above four evaluation indexes are taken as features of the image and are transmitted to the multi-layer perceptron (or called multi-layer perceptor) together with the image quality label of the local focus area manually annotated by the doctor, a difference loss (namely loss) between a network output result and the manually annotated result of the doctor is acquired, and a network weight is updated through back propagation. The multi-layer perceptor is continuously optimized to give a more accurate quality evaluation result.

FIG. 5 is an example of a multi-layer perceptron that generally includes an input layer, a plurality of hidden layers, and an output layer. In the example, the input layer has four neurons, corresponding to the input of four evaluation indexes, and the output layer has N neurons corresponding to N levels of the image quality evaluation of the focus area, where N is the number of quality levels set according to the actual needs. It can be seen from the above analysis that in a task of the image quality evaluation of the local focus area, the four quality evaluation indexes and the image quality annotated by the doctor are not completely linear, such that the perceptron needs to have the capability of nonlinear classification. A Sigmoid function may be used as an activation function after the output layer to add a non-linear component to the perceptron.

In summary, in step S30, by analyzing the four quality evaluation indexes for measuring the image quality of the focus area and the manually annotated result of the doctor, it is found that the four indexes and the annotated result have a positive correlation but are not completely linear, and therefore, the classifier is designed to learn the relationship between the four indexes and the manually annotated result of the doctor.

In step S140, the image quality is evaluated aiming at the target ultrasonic image with the trained classifier.

The above steps S110 to S130 are mainly described in terms of training the classifier using the sample image, and the trained classifier has the capability of performing the quality evaluation on the ultrasonic image containing the focus, and may be used for performing the quality evaluation on the focus area of the actual target ultrasonic image. For example, the application process includes: segmenting a focus area aiming at a target ultrasonic image to extract a region of interest and perform a masking operation to acquire an image segmentation result mask; taking the image segmentation result mask as a reference image, and quantitatively comparing the reference image with a corresponding focus area according to a set evaluation standard to acquire a plurality of evaluation result indexes; and inputting the plurality of evaluation result indexes as an image feature into a trained classifier to acquire a quality quantification result of the focus area of the target ultrasonic image. The application process of the classifier is similar to the training process, which is not described in detail here.

In order to further verify an evaluation effect of the present application on the image quality of the focus area, the experiment is performed, and the four quality evaluation indexes and the subjective quality evaluation result of the doctor corresponding to the image are input into the multi-layer perceptron to train, such that the multi-layer perceptron has the capability of evaluating the quality of the ultrasonic image containing the focus. In the experiment, in order to quantitatively measure the correlation between the output result of the quality evaluation network and the subjective evaluation result of the doctor, PLCC (Pearson linear correlation coefficient) is used as a measurement index. The Pearson linear correlation coefficient PLCC may be expressed by the following formula:

$${ρ}_{P} = \frac{{\sum }_{i = 1}^{N} ( {X}_{i} - \overline{X} ) ( {Y}_{i} - \overline{Y} )}{\sqrt{{\sum }_{i = 1}^{N} {( {X}_{i} - \overline{X} )}^{2} {\sum }_{i = 1}^{N} {( {Y}_{i} - \overline{Y} )}^{2}}} \qquad ( 3 )$$

where X and Y are a subjective evaluation score of the doctor and a quality evaluation result value output by the network, respectively, and N is the total number of data participating in comparison. PLCC describes the linear correlation between a subjective score and a network output score, with higher value giving better linear correlation. The closer the correlation coefficient is to 1 or −1, the stronger the correlation is, and the closer the correlation coefficient is to 0, the weaker the correlation is.

The experimental result shows that, with the accurate segmentation, the consistency between the evaluation result of the present application and the subjective evaluation result of the doctor may reach 0.897 PLCC, which has stronger clinical feasibility compared to other existing methods.

In summary, compared with the prior art, the present application has the following advantages
1) Global image quality evaluation cannot completely and accurately evaluate the quality of the ultrasonic image, and particularly for the image containing the focus, and thus the quality and the diagnostic value of the image are more dependent on the imaging quality of the image of the focus area. The difficulty of the automatic quality evaluation of the image of the local focus area lies in the lack of high quality reference images and the small size of the overall dataset, and the traditional method and the deep learning method cannot be applied to the problems. Aiming at the problems, the present application creatively introduces the segmentation mask acquired in the segmentation task, and converts an original non-reference image quality evaluation problem into a semi reference image quality evaluation problem.
2) The present application uses the segmented mask as the reference image, uses the plurality of the local image quality evaluation indexes of the focus area, and represents the similarity between the local image of the focus area and the segmented mask from a perspective of image semantic structure and image pixel statistics, such that the proposed ultrasonic image quality evaluation method has strong interpretability. And in order to acquire the result of the image quality evaluation of the focus area, the four quality evaluation indexes and the subjective quality evaluation result of the doctor corresponding to the image are input into the multi-layer perceptron to train, such that the multi-layer perceptron has the capability of evaluating the quality of the ultrasonic image containing the focus.
3) Compared with the traditional image processing algorithms, the present application has the advantages of low calculation cost, short time consumption, and strong interpretability, and overcomes the problem of large data scale of the deep learning algorithm.

The present application may be a system, a method and/or a computer program product. The computer program product may include a computer-readable storage medium having computer-readable program instructions loaded thereon for causing a processor to implement various aspects of the present application.

The computer-readable storage medium may be a tangible device that holds and stores the instructions for use by an instruction execution device. The computer-readable storage medium may include, but is not limited to, for example, an electronic storage device, a magnetic storage device, an optical storage device, an electromagnetic storage device, a semiconductor storage device, or any suitable combination of the foregoing. More specific examples (non-exhaustive list) of the computer-readable storage medium include: a portable computer disk, a hard disk drive, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanical coding device such as punch card or in-groove raised structure having instructions stored thereon, and any suitable combination of the foregoing. The computer-readable storage medium as used herein is not to be interpreted as a transitory signal per se, such as a radio wave or other freely propagating electromagnetic wave, an electromagnetic wave propagating through a waveguide or other transmission medium (e.g., optical pulses through a fiber optic cable), or an electrical signal transmitted through an electrical wire.

The computer-readable program instructions described herein may be downloaded from a computer-readable storage medium to computing/processing devices, or to an external computer or external storage device via a network, such as the Internet, a local area network, a wide area network and/or a wireless network. The network may include copper transmission cables, optical fiber transmission, wireless transmission, routers, firewalls, switches, gateway computers and/or edge servers. The network adapter card or network interface in each computing/processing device receives a computer-readable program instruction from the network and forwards the computer-readable program instruction for storage in a computer-readable storage medium in each computing/processing device.

Computer program instructions for executing operations of the present application may be assembler instructions, instruction set architecture (ISA) instructions, machine instructions, machine-related instructions, microcode, firmware instructions, state setting data, or source or object code in any combination of one or more programming languages including an object-oriented programming language such as Smalltalk, C++ and Python, and a conventional procedural programming language such as the “C” language or similar programming languages. The computer-readable program instructions may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet service provider). In some embodiments, aspects of the present application are implemented by personalizing an electronic circuit, such as a programmable logic circuit, a field programmable gate array (FPGA) or a programmable logic array (PLA), with state information of computer-readable program instructions, the electronic circuit being capable of executing the computer-readable program instructions.

Aspects of the present application are described herein with reference to a flowchart and/or block diagrams of methods, apparatus (systems) and computer program products according to embodiments of the present application. It should be understood that each block of the flowchart and/or block diagrams, and combinations of blocks in the flowchart and/or block diagrams, can be implemented by computer-readable program instructions.

These computer-readable program instructions can be provided to the processor of a general-purpose computer, a special-purpose computer, or other programmable data processing apparatus, thereby producing a machine that causes these instructions, when executed by the processor of the computer or other programmable data processing apparatus, to produce an apparatus that implements the functions/motions specified in one or more blocks of the flowchart and/or block diagrams. These computer-readable program instructions may also be stored in a computer-readable storage medium, wherein these instructions can direct a computer, a programmable data processing apparatus and/or other devices to function in a particular manner, such that the computer-readable medium storing the instructions comprises an article of manufacture including instructions which implement the functions/motions specified in the one or more blocks of the flowchart and/or block diagrams.

The computer-readable program instructions may also be loaded onto a computer, other programmable data processing apparatus or other devices to cause a series of operational steps to be executed on the computer, other programmable apparatus or other devices to produce a computer implemented process such that the instructions executed on the computer, other programmable data processing apparatus or other devices implement the functions/motions specified in the one or more blocks of the flowchart and/or block diagrams.

The flowchart and block diagrams in the figures illustrate the architecture, functions, and operation of possible implementations of the system, method and computer program product according to various embodiments of the present application. In this regard, each block in the flowchart or block diagrams may represent a portion of a module, segment or instructions which comprises one or more executable instructions for implementing the specified logical functions. In some alternative implementations, the functions noted in the blocks may occur out of the order noted in the figures. For example, two blocks shown in succession may, in fact, be executed substantially concurrently, or the blocks may sometimes be executed in the reverse order, depending upon the functions involved. It should also be noted that each block in the block diagrams and/or the flowchart, and combinations of blocks in the block diagrams and/or the flowchart, can be implemented by special-purpose hardware-based systems that perform the specified functions or motions, or by combinations of special-purpose hardware and computer instructions. It is well known to those skilled in the art that the implementations by hardware and software and a combination of software and hardware are equivalent.

While various embodiments of the present application have been described above, the descriptions are exemplary, not exhaustive, and not limited to the disclosed embodiments. Many modifications and variations will be apparent to those of ordinary skill in the art without departing from the scope and spirit of the described embodiments. The terms used herein are chosen in order to best explain the principles of the embodiments, the practical application or technical improvements in the market, or to enable others of ordinary skill in the art to understand the embodiments disclosed herein. The scope of the present application is defined by the appended claims.

1. An ultrasonic image quality quantitative evaluation method, comprising the following steps:
segmenting a focus area aiming at a target ultrasonic image to extract a region of interest and perform a masking operation to acquire an image segmentation result mask, wherein the image segmentation result mask corresponds to a focus area outline;
taking the image segmentation result mask as a reference image, and quantitatively comparing the reference image with a corresponding focus area according to a set evaluation standard to acquire a plurality of evaluation result indexes; and
inputting the plurality of evaluation result indexes as an image feature into a classifier to acquire a quality quantification result of the focus area of the target ultrasonic image, wherein the classifier takes the plurality of evaluation result indexes corresponding to a sample image as an input feature, takes an image quality label of the labeled local focus area as an output, and acquires the quality quantification result through training based on a set loss function.

2. The ultrasonic image quality quantitative evaluation method according to claim 1, wherein the plurality of evaluation result indexes comprise a mean square error MSE, a peak signal-to-noise ratio PSNR, a focus contrast ratio, and a structural similarity, wherein the mean square error MSE is a mean value used for measuring a difference value between two images, the peak signal-to-noise ratio PSNR is a ratio of an intensity of a peak signal to an average intensity of noise, the focus contrast ratio is used for measuring distinguishability between an image of the focus area and a focus surrounding area, and the structural similarity is used for measuring a degree of the structural similarity between focus area imaging and a reference image mask.

3. The ultrasonic image quality quantitative evaluation method according to claim 2, wherein the focus contrast ratio is defined as a difference value between an image pixel mean value of the focus surrounding area and an image pixel mean value of the focus area divided by a maximum pixel value, and the structural similarity is defined as a Dice coefficient between a segmentation result acquired by using an OTSU threshold segmentation algorithm on the region of interest and the reference image mask.

4. The ultrasonic image quality quantitative evaluation method according to claim 2, wherein the mean square error MSE is expressed as:
$$MSE = \frac{1}{MN} {\sum }_{x = 0}^{M - 1} {\sum }_{y = 0}^{N - 1} {[ A ( x , y ) - B ( x , y ) ]}^{2}$$
wherein A and B represent two images to be compared, A(x, y) and B(x, y) represent gray values of a pixel (x, y) in an image A and an image B, respectively, and M and N represent a number of pixels of an image in a length direction and a width direction, respectively.

5. The ultrasonic image quality quantitative evaluation method according to claim 2, wherein the peak signal-to-noise ratio PSNR is expressed as:
$$PSNR = 10 {log}_{10} \frac{{MaxValue}^{2}}{MSE}$$
wherein MaxValue represents a maximum gray value in an image, and MSE is a mean square error of two images.

6. The ultrasonic image quality quantitative evaluation method according to claim 2, wherein the classifier is a multi-layer perceptron.

7. The ultrasonic image quality quantitative evaluation method according to claim 6, wherein a number of neurons contained in an input layer of the multi-layer perceptron coincides with a number of the plurality of evaluation indexes, a number of neurons contained in an output layer of the multi-layer perceptron coincides with a set number of levels of image quality evaluation of the focus area, and a Sigmoid function is used as an activation function after the output layer.

8. The ultrasonic image quality quantitative evaluation method according to claim 1, further comprising: feeding back the acquired quality quantization result of the focus area of the target ultrasonic image to an ultrasonic automatic acquisition device to adjust a pose of an ultrasonic probe.

9. A computer-readable storage medium having a computer program stored thereon, wherein the computer program, when executed by a processor, implements steps of the ultrasonic image quality quantitative evaluation method according to claim 1.

10. A computer device, comprising a memory and a processor, a computer program capable of operating on the processor being stored on the memory, wherein the processor, when executing the computer program, implements the steps of the ultrasonic image quality quantitative evaluation method according to claim 1.
